(19) United States
(12) Patent Application Publication
(10) Pub. No.: US 2021/0178661 A1
(43) Pub. Date: Jun. 17, 2021

(54) Three-Dimensional Printing System Employing A Toughened Polyarylene Sulfide Composition

(71) Applicant: Ticona LLC, Florence, KY (US)

(72) Inventors: Craig J. Peterson, Hebron, KY (US); Xinyu Zhao, Cincinnati, OH (US); Yuehua Yu, Cincinnati, OH (US)

(21) Appl. No.: 17/120,351

(22) Filed: Dec. 14, 2020

Related U.S. Application Data
(60) Provisional application No. 62/948,868, filed on Dec. 17, 2019.

(51) Int. Cl. B29C 64/118; B29C 64/209; B29C 64/268; B29C 64/255; B33Y 70/00; B29C 64/329

(52) U.S. Cl. CPC B29C 64/118; B29C 64/209; B29C 64/268; B33Y 10/00; B33Y 70/00; B29C 64/329; B29C 64/255

(57) ABSTRACT

A three-dimensional printing method is provided. The method comprises selectively forming a three-dimensional structure from a polymer composition. The polymer composition comprises a polyarylene sulfide and an impact modifier.

### RELATED APPLICATION

The present application claims priority to U.S. Provisional Application Ser. No. 62/948,868, filed on Dec. 17, 2019, which is incorporated herein in its entirety by reference thereto.

### BACKGROUND OF THE INVENTION

Additive manufacturing, also called three-dimensional or 3D printing, is generally a process in which a three-dimensional structure is selectively formed from a digital model. Various types of three-dimensional printing techniques may be employed, such as fused deposition modeling, ink jetting, powder bed fusion (e.g., selective laser sintering), powder/binder jetting, electron-beam melting, electrophotographic imaging, and so forth. In a fused deposition modeling system, for instance, a build material may be extruded through an extrusion tip carried by a print nozzle of the system, and then deposited as a sequence of layers on a substrate. The extruded material fuses to previously deposited material, and solidifies upon a drop in temperature. The position of the print nozzle relative to the substrate may be incremented along an axis (perpendicular to the build plane) after each layer is formed, and the process may then be repeated to form a printed part resembling the digital representation. If desired, supporting layers or structures can also be built underneath overhanging portions or in cavities of printed parts under construction, which are not supported by the build material itself. The support structure adheres to the part material during fabrication, and is removable from the completed printed part when the printing process is complete. Regardless of the particular technique, three-dimensional printing has been more commonly employed to form plastic parts. Unfortunately, its use has still been somewhat limited in advanced product applications that require a higher level of material performance, such as high thermal stability and heat resistance, enhanced flow, and good mechanical properties. One reason for this limitation is that the polymeric materials commonly employed in three-dimensional printing systems, such as polylactic acid and polyethylene, generally lack high performance properties. Conversely, attempts at employing high performance polymers have often failed as such polymers tend to lack the requisite mechanical properties required for three-dimensional printing.

As such, a need exists for a high performance polymer composition that can be readily employed in a three-dimensional printing system.

### SUMMARY OF THE INVENTION

In accordance with one embodiment of the present invention, a three-dimensional printing method is disclosed that comprises selectively forming a three-dimensional structure from a polymer composition. The polymer composition comprises a polyarylene sulfide and an impact modifier. In accordance with another embodiment of the present invention, a printer cartridge for use in a three-dimensional printing system is disclosed that comprises a filament that is formed from a polymer composition, such as described above. In accordance with yet another embodiment of the present invention, a three-dimensional printing system is disclosed that comprises a supply source containing a polymer composition, such as described above, and a nozzle that is configured to receive the polymer composition from the supply source and deposit the composition onto a substrate. In accordance with still another embodiment of the present invention, a three-dimensional printing system is disclosed that comprises a powder supply comprising a plurality of particles formed from a polymer composition, such as described above; a powder bed configured to receive the powder supply; and an energy source for selectively fusing the powder supply when present within the powder bed.

Other features and aspects of the present invention are set forth in greater detail below.

### BRIEF DESCRIPTION OF THE FIGURES

A full and enabling disclosure of the present invention, including the best mode thereof to one skilled in the art, is set forth more particularly in the remainder of the specification, including reference to the accompanying figures, in which:

FIG. 1 is a front view of one embodiment of a fused deposition modeling system that may be employed in the present invention;

FIG. 2 is a perspective view of one embodiment of a three-dimensional structure that may be formed from the polymer composition of the present invention;

FIGS. 3A-3C are cross-sectional views of FIG. 2 taken along a line 3A-3A, depicting a process for forming a three-dimensional structure;

FIG. 4 is an exploded perspective view of one embodiment of a printer cartridge that may be employed in the present invention; and

FIG. 5 is a schematic view of one embodiment of a powder bed fusion system that may be employed in the present invention.

### DETAILED DESCRIPTION

It is to be understood by one of ordinary skill in the art that the present discussion is a description of exemplary embodiments only, and is not intended as limiting the broader aspects of the present invention.

Generally speaking, the present invention is directed to a three-dimensional printing system and method that employs a polymer composition that contains a polyarylene sulfide and an impact modifier. By selectively controlling the specific aspects of the components of the composition, the present inventors have discovered that the resulting composition can achieve certain unique properties that enable the composition to be readily employed in a three-dimensional printing system. More particularly, the composition may exhibit a unique combination of good flow and high strength properties. For example, the polymer composition may possess a relatively low melt viscosity, such as about 8,000 poise or less, in some embodiments about 7,000 poise or less, in some embodiments from about 1,000 to about 6,000 poise, in some embodiments from about 2,500 to about 5,500, and in some embodiments, from about 3,000 to about 5,000 poise, as determined by a capillary rheometer at a shear rate of 1,200 seconds⁻¹. Among other things, these viscosity properties can allow the composition to be readily three-dimensionally printed into parts having a small dimension.

Due to the relatively low melt viscosity that can be achieved in the present invention, relatively high molecular weight polyarylene sulfides may be employed with little difficulty. For example, such high molecular weight polyarylene sulfides may have a number average molecular weight of about 14,000 grams per mole (“g/mol”) or more, in some embodiments about 15,000 g/mol or more, and in some embodiments, from about 16,000 g/mol to about 60,000 g/mol, as well as weight average molecular weight of about 35,000 g/mol or more, in some embodiments about 50,000 g/mol or more, and in some embodiments, from about 60,000 g/mol to about 90,000 g/mol, as determined using gel permeation chromatography as described below. One benefit of using such high molecular weight polymers is that they generally have a low chlorine content. In this regard, the resulting polymer composition may have a low chlorine content, such as about 1200 ppm or less, in some embodiments about 900 ppm or less, in some embodiments from 0 to about 800 ppm, and in some embodiments, from about 1 to about 500 ppm.

In addition, the crystallization temperature (prior to three-dimensional printing) of the polymer composition may about 250° C. or less, in some embodiments from about 100° C. to about 245° C., and in some embodiments, from about 150° C. to about 240° C. The melting temperature of the polymer composition may also range from about 250° C. to about 320° C., and in some embodiments, from about 260° C. to about 300° C. The melting and crystallization temperatures may be determined as is well known in the art using differential scanning calorimetry in accordance with ISO Test No. 11357-1:2016. The temperature at which three-dimensional printing may be conducted (i.e., the “operating window”) is typically between the melting temperature and the crystallization temperature. For example, the temperature at which three-dimensional printing may be conducted may be at a temperature from about 200° C. to about 300° C., in some embodiments from about 210° C. to about 290° C., and in some embodiments, from about 225° C. to about 280° C. One particular benefit of the present invention is that the difference between the crystallization and melting temperatures is relatively large, which provides a broad operating window for three-dimensional printing. That is, the operating window is typically from about 10° C. to about 100° C., in some embodiments from about 25° C. to about 75° C., and in some embodiments, from about 40° C. to about 60° C.

The resulting polymer composition has also been found to possess excellent mechanical properties. For example, the present inventors have discovered that the impact strength of the composition can be significantly improved, which is useful in three-dimensional printing. For example, the composition may exhibit a Charpy notched impact strength of about 5 kJ/m² or more, in some embodiments from about 8 to about 40 kJ/m², and in some embodiments, from about 10 to about 30 kJ/m², measured at 23° C. according to ISO Test No. 179-1:2010) (technically equivalent to ASTM D256-10, Method B). Despite having a low melt viscosity and high impact strength, the present inventors have also discovered that the tensile and flexural mechanical properties are not adversely impacted. For example, the composition may exhibit a tensile strength of from about 20 to about 500 MPa, in some embodiments from about 50 to about 400 MPa, and in some embodiments, from about 100 to about 350 MPa; a tensile break strain of about 0.5% or more, in some embodiments from about 0.6% to about 10%, and in some embodiments, from about 0.8% to about 3.5%; and/or a tensile modulus of from about 3,000 MPa to about 30,000 MPa, in some embodiments from about 4,000 MPa to about 25,000 MPa, and in some embodiments, from about 5,000 MPa to about 22,000 MPa. The tensile properties may be determined in accordance with ISO Test No. 527:2012 (technically equivalent to ASTM D638-14) at 23° C. The composition may also exhibit a flexural strength of from about 20 to about 500 MPa, in some embodiments from about 50 to about 400 MPa, and in some embodiments, from about 100 to about 350 MPa; a flexural break strain of about 0.5% or more, in some embodiments from about 0.6% to about 10%, and in some embodiments, from about 0.8% to about 3.5%; and/or a flexural modulus of from about 3,000 MPa to about 30,000 MPa, in some embodiments from about 4,000 MPa to about 25,000 MPa, and in some embodiments, from about 5,000 MPa to about 22,000 MPa. The flexural properties may be determined in accordance with ISO Test No. 178:2010 (technically equivalent to ASTM D790-10) at 23° C.

The ratio of the deflection temperature under load (“DTUL”), a measure of short term heat resistance, to the melting temperature may also be relatively high. For example, the ratio may range from about 0.65 to about 1.00, in some embodiments from about 0.70 to about 0.99, and in some embodiments, from about 0.80 to about 0.98. The specific DTUL values may, for instance, range from about 200° C. to about 300° C., in some embodiments from about 230° C. to about 290° C., and in some embodiments, from about 250° C. to about 280° C. Such high DTUL values can, among other things, allow the use of high speed three-dimensional printing processes having a small dimensional tolerance.

Various embodiments of the present invention will now be described in more detail.

### I. Polymer Composition

A. Polyarylene Sulfide

Polyarylene sulfides typically constitute from about 25 wt. % to about 95 wt. %, in some embodiments from about 30 wt. % to about 80 wt. %, and in some embodiments, from about 40 wt. % to about 70 wt. % of the polymer composition. The polyarylene sulfide(s) employed in the composition generally have repeating units of the formula:

—[(Ar¹)ₙ—X]ₘ—[(Ar²)ᵢ—Y]ⱼ—[(Ar³)ₖ—Z]ₗ—[(Ar⁴)ₒ—W]ₚ—

wherein,

Ar¹, Ar², Ar³, and Ar⁴ are independently arylene units of 6 to 18 carbon atoms;

W, X, Y, and Z are independently bivalent linking groups selected from —SO₂—, —S—, —SO—, —CO—, —O—, —C(O)O— or alkylene or alkylidene groups of 1 to 6 carbon atoms, wherein at least one of the linking groups is —S—; and

n, m, i, j, k, l, o, and p are independently 0, 1, 2, 3, or 4, subject to the proviso that their sum total is not less than 2.

The arylene units Ar¹, Ar², Ar³, and Ar⁴ may be selectively substituted or unsubstituted. Advantageous arylene units are phenylene, biphenylene, naphthylene, anthracene and phenanthrene. The polyarylene sulfide typically includes more than about 30 mol %, more than about 50 mol %, or more than about 70 mol % arylene sulfide (—S—) units. For example, the polyarylene sulfide may include at least 85 mol % sulfide linkages attached directly to two aromatic rings. In one particular embodiment, the polyarylene sulfide is a polyphenylene sulfide, defined herein as containing the phenylene sulfide structure —(C₆H₄—S)ₙ— (wherein n is an integer of 1 or more) as a component thereof.

Synthesis techniques that may be used in making a polyarylene sulfide are generally known in the art. By way of example, a process for producing a polyarylene sulfide can include reacting a material that provides a hydrosulfide ion (e.g., an alkali metal sulfide) with a dihaloaromatic compound in an organic amide solvent. The alkali metal sulfide can be, for example, lithium sulfide, sodium sulfide, potassium sulfide, rubidium sulfide, cesium sulfide or a mixture thereof. When the alkali metal sulfide is a hydrate or an aqueous mixture, the alkali metal sulfide can be processed according to a dehydrating operation in advance of the polymerization reaction. An alkali metal sulfide can also be generated in situ. In addition, a small amount of an alkali metal hydroxide can be included in the reaction to remove or react impurities (e.g., to change such impurities to harmless materials) such as an alkali metal polysulfide or an alkali metal thiosulfate, which may be present in a very small amount with the alkali metal sulfide.

The dihaloaromatic compound can be, without limitation, an o-dihalobenzene, m-dihalobenzene, p-dihalobenzene, dihalotoluene, dihalonaphthalene, methoxy-dihalobenzene, dihalobiphenyl, dihalobenzoic acid, dihalodiphenyl ether, dihalodiphenyl sulfone, dihalodiphenyl sulfoxide or dihalodiphenyl ketone. Dihaloaromatic compounds may be used either singly or in any combination thereof. Specific exemplary dihaloaromatic compounds can include, without limitation, p-dichlorobenzene; m-dichlorobenzene; o-dichlorobenzene; 2,5-dichlorotoluene; 1,4-dibromobenzene, 1,4-dichloronaphthalene; 1-methoxy-2,5-dichlorobenzene; 4,4′-dichlorobiphenyl; 3,5-dichlorobenzoic acid; 4,4′-dichlorodiphenyl ether; 4,4′-dichlorodiphenylsulfone; 4,4′-dichlorodiphenylsulfoxide; and 4,4′-dichlorodiphenyl ketone. The halogen atom can be fluorine, chlorine, bromine or iodine, and two halogen atoms in the same dihalo-aromatic compound may be the same or different from each other. In one embodiment, o-dichlorobenzene, m-dichlorobenzene, p-dichlorobenzene or a mixture of two or more compounds thereof is used as the dihalo-aromatic compound. As is known in the art, it is also possible to use a monohalo compound (not necessarily an aromatic compound) in combination with the dihaloaromatic compound in order to form end groups of the polyarylene sulfide or to regulate the polymerization reaction and/or the molecular weight of the polyarylene sulfide.

The polyarylene sulfide(s) may be homopolymers or copolymers. For instance, selective combination of dihaloaromatic compounds can result in a polyarylene sulfide copolymer containing not less than two different units. For instance, when p-dichlorobenzene is used in combination with m-dichlorobenzene or 4,4′-dichlorodiphenylsulfone, a polyarylene sulfide copolymer can be formed containing segments having the structure of formula:

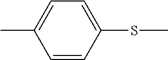

and segments having the structure of formula:

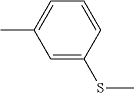

or segments having the structure of formula:

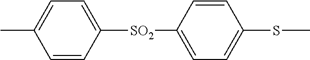

The polyarylene sulfide(s) may be linear, semi-linear, branched or crosslinked. Linear polyarylene sulfides typically contain 80 mol % or more of the repeating unit —(Ar—S)—. Such linear polymers may also include a small amount of a branching unit or a cross-linking unit, but the amount of branching or cross-linking units is typically less than about 1 mol % of the total monomer units of the polyarylene sulfide. A linear polyarylene sulfide polymer may be a random copolymer or a block copolymer containing the above-mentioned repeating unit. Semi-linear polyarylene sulfides may likewise have a cross-linking structure or a branched structure introduced into the polymer a small amount of one or more monomers having three or more reactive functional groups. By way of example, monomer components used in forming a semi-linear polyarylene sulfide can include an amount of polyhaloaromatic compounds having two or more halogen substituents per molecule which can be utilized in preparing branched polymers. Such monomers can be represented by the formula R′Xₙ, where each X is selected from chlorine, bromine, and iodine, n is an integer of 3 to 6, and R′ is a polyvalent aromatic radical of valence n which can have up to about 4 methyl substituents, the total number of carbon atoms in R′ being within the range of 6 to about 16. Examples of some polyhaloaromatic compounds having more than two halogens substituted per molecule that can be employed in forming a semi-linear polyarylene sulfide include 1,2,3-trichlorobenzene, 1,2,4-trichlorobenzene, 1,3-dichloro-5-bromobenzene, 1,2,4-triiodobenzene, 1,2,3,5-tetrabromobenzene, hexachlorobenzene, 1,3,5-trichloro-2,4,6-trimethylbenzene, 2,2′,4,4′-tetrachlorobiphenyl, 2,2′,5,5′-tetra-iodobiphenyl, 2,2′,6,6′-tetrabromo-3,3′,5,5′-tetramethylbiphenyl, 1,2,3,4-tetrachloronaphthalene, 1,2,4-tribromo-6-methylnaphthalene, etc., and mixtures thereof.

B. Impact Modifier

Impact modifiers typically constitute from about 1 wt. % to about 40 wt. %, in some embodiments from about 2 wt. % to about 30 wt. %, and in some embodiments, from about 3 wt. % to about 25 wt. % of the polymer composition. Examples of suitable impact modifiers may include, for instance, polyepoxides, polyurethanes, polybutadiene, acrylonitrile-butadiene-styrene, polyamides, block copolymers (e.g., polyether-polyamide block copolymers), etc., as well as mixtures thereof. In one embodiment, an olefin copolymer is employed that is “epoxy-functionalized” in that it contains, on average, two or more epoxy functional groups per molecule. The copolymer generally contains an olefinic monomeric unit that is derived from one or more α-olefins. Examples of such monomers include, for instance, linear and/or branched α-olefins having from 2 to 20 carbon atoms and typically from 2 to 8 carbon atoms. Specific examples include ethylene, propylene, 1-butene; 3-methyl-1-butene, 3,3-dimethyl-1-butene, 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. Particularly desired α-olefin monomers are ethylene and propylene. The copolymer may also contain an epoxy-functional monomeric unit. One example of such a unit is an epoxy-functional (meth)acrylic monomeric component. As used herein, the term “(meth)acrylic” includes acrylic and methacrylic monomers, as well as salts or esters thereof, such as acrylate and methacrylate monomers. For example, suitable epoxy-functional (meth)acrylic monomers may include, but are not limited to, those containing 1,2-epoxy groups, such as glycidyl acrylate and glycidyl methacrylate. Other suitable epoxy-functional monomers include allyl glycidyl ether, glycidyl ethacrylate, and glycidyl itoconate. Other suitable monomers may also be employed to help achieve the desired molecular weight.

Of course, the copolymer may also contain other monomeric units as is known in the art. For example, another suitable monomer may include a (meth)acrylic monomer that is not epoxy-functional. Examples of such (meth)acrylic monomers may include methyl acrylate, ethyl acrylate, n-propyl acrylate, i-propyl acrylate, n-butyl acrylate, s-butyl acrylate, i-butyl acrylate, t-butyl acrylate, n-amyl acrylate, i-amyl acrylate, isobornyl acrylate, n-hexyl acrylate, 2-ethylbutyl acrylate, 2-ethylhexyl acrylate, n-octyl acrylate, n-decyl acrylate, methylcyclohexyl acrylate, cyclopentyl acrylate, cyclohexyl acrylate, methyl methacrylate, ethyl methacrylate, 2-hydroxyethyl methacrylate, n-propyl methacrylate, n-butyl methacrylate, i-propyl methacrylate, i-butyl methacrylate, n-amyl methacrylate, n-hexyl methacrylate, i-amyl methacrylate, s-butyl-methacrylate, t-butyl methacrylate, 2-ethylbutyl methacrylate, methylcyclohexyl methacrylate, cinnamyl methacrylate, crotyl methacrylate, cyclohexyl methacrylate, cyclopentyl methacrylate, 2-ethoxyethyl methacrylate, isobornyl methacrylate, etc., as well as combinations thereof. In one particular embodiment, for example, the copolymer may be a terpolymer formed from an epoxy-functional (meth)acrylic monomeric component, α-olefin monomeric component, and non-epoxy functional (meth)acrylic monomeric component. The copolymer may, for instance, be poly(ethylene-co-butylacrylate-co-glycidyl methacrylate), which has the following structure:

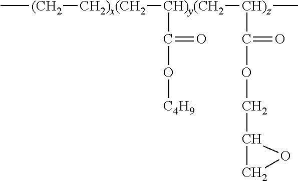

wherein, x, y, and z are 1 or greater.

The relative portion of the monomeric component(s) may be selected to achieve a balance between epoxy-reactivity and melt flow rate. More particularly, high epoxy monomer contents can result in good reactivity with the matrix polymer, but too high of a content may reduce the melt flow rate to such an extent that the copolymer adversely impacts the melt strength of the polymer blend. Thus, in most embodiments, the epoxy-functional (meth)acrylic monomer(s) constitute from about 1 wt. % to about 20 wt. %, in some embodiments from about 2 wt. % to about 15 wt. %, and in some embodiments, from about 3 wt. % to about 10 wt. % of the copolymer. The α-olefin monomer(s) may likewise constitute from about 55 wt. % to about 95 wt. %, in some embodiments from about 60 wt. % to about 90 wt. %, and in some embodiments, from about 65 wt. % to about 85 wt. % of the copolymer. When employed, other monomeric components (e.g., non-epoxy functional (meth)acrylic monomers) may constitute from about 5 wt. % to about 35 wt. %, in some embodiments from about 8 wt. % to about 30 wt. %, and in some embodiments, from about 10 wt. % to about 25 wt. % of the copolymer. The result melt flow rate is typically from about 1 to about 30 grams per 10 minutes (“g/10 min”), in some embodiments from about 2 to about 20 g/10 min, and in some embodiments, from about 3 to about 15 g/10 min, as determined in accordance with ASTM D1238-13 at a load of 2.16 kg and temperature of 190° C.

One example of a suitable epoxy-functionalized copolymer that may be used in the present invention is commercially available from Arkema under the name LOTADER® AX8840. LOTADER® AX8840, for instance, has a melt flow rate of 5 g/10 min and is a random copolymer of ethylene and a glycidyl methacrylate (monomer content of 8 wt. %). Another suitable copolymer is commercially available from DuPont under the name ELVALOY® PTW, which is a terpolymer of ethylene, butyl acrylate, and glycidyl methacrylate and has a melt flow rate of 12 g/10 min and a glycidyl methacrylate monomer content of 4 wt. % to 5 wt. %.

C. Other Optional Components

A wide variety of additional additives can also be included in the polymer composition, such as fillers (e.g., fibers, particulate fillers, etc.), coupling agents, crosslinking agents, nucleating agents, lubricants, flow modifiers, pigments, antioxidants, stabilizers, surfactants, waxes, flame retardants, anti-drip additives, and other materials added to enhance properties and processability. Various optional additives are described below.

i. Fillers

In certain embodiments, fibrous fillers, such as inorganic fibers, may be employed, such as an in an amount of from about 1 wt. % to about 50 wt. %, in some embodiments from about 2 wt. % to about 40 wt. %, and in some embodiments, from about 5 wt. % to about 30 wt. % of the polymer composition. Any of a variety of different types of inorganic fibers may generally be employed, such as those that are derived from glass; silicates, such as neosilicates, sorosilicates, inosilicates (e.g., calcium inosilicates, such as wollastonite; calcium magnesium inosilicates, such as tremolite; calcium magnesium iron inosilicates, such as actinolite; magnesium iron inosilicates, such as anthophyllite; etc.), phyllosilicates (e.g., aluminum phyllosilicates, such as palygorskite), tectosilicates, etc.; sulfates, such as calcium sulfates (e.g., dehydrated or anhydrous gypsum); mineral wools (e.g., rock or slag wool); and so forth. Glass fibers are particularly suitable for use in the present invention, such as those formed from E-glass, A-glass, C-glass, D-glass, AR-glass, R-glass, S1-glass, S2-glass, etc., as well as mixtures thereof. If desired, the glass fibers may be provided with a sizing agent or other coating as is known in the art.

The inorganic fibers may have any desired cross-sectional shape, such as circular, flat, etc. In certain embodiments, it may be desirable to employ fibers having a relatively flat cross-sectional dimension in that they have an aspect ratio (i.e., cross-sectional width divided by cross-sectional thickness) of from about 1.5 to about 10, in some embodiments from about 2 to about 8, and in some embodiments, from about 3 to about 5.

Particulate fillers may also be employed in the polymer composition. When employed, particulate fillers typically constitute from about 5 wt. % to about 60 wt. %, in some embodiments from about 10 wt. % to about 50 wt. %, and in some embodiments, from about 15 wt. % to about 45 wt. % of the polymer composition. Various types of particulate fillers may be employed as is known in the art. Clay minerals, for instance, may be particularly suitable for use in the present invention. Examples of such clay minerals include, for instance, talc (Mg₃Si₄O₁₀(OH)₂), halloysite (Al₂Si₂O₅(OH)₄), kaolinite (Al₂Si₂O₅(OH)₄), illite ((K,H₃O)(Al,Mg,Fe)₂ (Si,Al)₄O₁₀[(OH)₂,(H₂O)]), montmorillonite (Na,Ca)_{0.33}(Al,Mg)₂Si₄O₁₀(OH)₂.nH₂O), vermiculite ((MgFe,Al)₃(Al,Si)₄O₁₀(OH)₂.4H₂O), palygorskite ((Mg,Al)₂Si₄O₁₀(OH).4(H₂O)), pyrophyllite (Al₂Si₄O₁₀(OH)₂), etc., as well as combinations thereof. In lieu of, or in addition to, clay minerals, still other mineral fillers may also be employed. For example, other suitable silicate fillers may also be employed, such as calcium silicate, aluminum silicate, mica, diatomaceous earth, wollastonite, and so forth. Mica, for instance, may be a particularly suitable mineral for use in the present invention. There are several chemically distinct mica species with considerable variance in geologic occurrence, but all have essentially the same crystal structure. As used herein, the term “mica” is meant to generically include any of these species, such as muscovite (KAl₂(AlSi₃)O₁₀(OH)₂), biotite (K(Mg,Fe)₃(AlSi₃)O₁₀(OH)₂), phlogopite (KMg₃(AlSi₃)O₁₀(OH)₂), lepidolite (K(Li,Al)₂-3(AlSi₃)O₁₀(OH)₂), glauconite (K,Na)(Al,Mg,Fe)₂(Si,Al)₄O₁₀(OH)₂), etc., as well as combinations thereof.

ii. Coupling Agent

If desired, the polymer composition may employ a coupling agent, such as an organosilane compound. Such organosilane compounds typically constitute from about 0.01 wt. % to about 3 wt. %, in some embodiments from about 0.02 wt. % to about 1 wt. %, and in some embodiments, from about 0.05 to about 0.5 wt. % of the polymer composition. The organosilane compound may, for example, be any alkoxysilane as is known in the art, such as vinlyalkoxysilanes, epoxyalkoxysilanes, aminoalkoxysilanes, mercaptoalkoxysilanes, and combinations thereof. In one embodiment, for instance, the organosilane compound may have the following general formula:

R⁵—Si—(R⁶)₃,

wherein,

R⁵ is a sulfide group (e.g., —SH), an alkyl sulfide containing from 1 to 10 carbon atoms (e.g., mercaptopropyl, mercaptoethyl, mercaptobutyl, etc.), alkenyl sulfide containing from 2 to 10 carbon atoms, alkynyl sulfide containing from 2 to 10 carbon atoms, amino group (e.g., NH₂), aminoalkyl containing from 1 to 10 carbon atoms (e.g., aminomethyl, aminoethyl, aminopropyl, aminobutyl, etc.); aminoalkenyl containing from 2 to 10 carbon atoms, aminoalkynyl containing from 2 to 10 carbon atoms, and so forth;

R⁶ is an alkoxy group of from 1 to 10 carbon atoms, such as methoxy, ethoxy, propoxy, and so forth.

Some representative examples of organosilane compounds that may be included in the mixture include mercaptopropyl trimethyoxysilane, mercaptopropyl triethoxysilane, aminopropyl triethoxysilane, aminoethyl triethoxysilane, aminopropyl trimethoxysilane, aminoethyl trimethoxysilane, ethylene trimethoxysilane, ethylene triethoxysilane, ethyne trimethoxysilane, ethyne triethoxysilane, aminoethylaminopropyltrimethoxysilane, 3-aminopropyl triethoxysilane, 3-aminopropyl trimethoxysilane, 3-aminopropyl methyl dimethoxysilane or 3-aminopropyl methyl diethoxysilane, N-(2-aminoethyl)-3-aminopropyl trimethoxysilane, N-methyl-3-aminopropyl trimethoxysilane, N-phenyl-3-aminopropyl trimethoxysilane, bis(3-aminopropyl) tetramethoxysilane, bis(3-aminopropyl) tetraethoxy disiloxane, γ-aminopropyltrimethoxysilane, γ-aminopropyltriethoxysilane, γ-aminopropylmethyldimethoxysilane, γ-aminopropylmethyldiethoxysilane, N-(β-aminoethyl)-γ-aminopropyltrimethoxysilane, N-phenyl-γ-aminopropyltrimethoxysilane, γ-diallylaminopropyltrimethoxysilane, γ-diallylaminopropyltrimethoxysilane, etc., as well as combinations thereof. Particularly suitable organosilane compounds are 3-aminopropyltriethoxysilane and 3-mercaptopropyltrimethoxysilane.

iii. Crosslinking Agent

If desired, crosslinking agents may also be employed in the polymer composition that can react with chains of the impact modifier to further increase strength. When employed, such crosslinking agents typically constitute from about 0.05 wt. % to about 15 wt. %, in some embodiments from about 0.1 wt. % to about 10 wt. %, and in some embodiments, from about 0.2 wt. % to about 5 wt. % of the polymer composition.

One embodiment such a crosslinking agent is a metal carboxylate. Without intending to be limited by theory, it is believed that the metal atom in the carboxylate can act as a Lewis acid that accepts electrons from the oxygen atom located in the epoxy functional group of the impact modifier. Once it reacts with the carboxylate, the epoxy functional group becomes activated and can be readily attacked at either carbon atom in the three-membered ring via nucleophilic substitution, thereby resulting in crosslinking between the chains of the impact modifier. The metal carboxylate is typically a metal salt of a fatty acid. The metal cation employed in the salt may vary, but is typically a divalent metal, such as calcium, magnesium, lead, barium, strontium, zinc, iron, cadmium, nickel, copper, tin, etc., as well as mixtures thereof. Zinc is particularly suitable. The fatty acid may generally be any saturated or unsaturated acid having a carbon chain length of from about 8 to 22 carbon atoms, and in some embodiments, from about 10 to about 18 carbon atoms. If desired, the acid may be substituted. Suitable fatty acids may include, for instance, lauric acid, myristic acid, behenic acid, oleic acid, palmitic acid, stearic acid, ricinoleic acid, capric acid, neodecanoic acid, hydrogenated tallow fatty acid, hydroxy stearic acid, the fatty acids of hydrogenated castor oil, erucic acid, coconut oil fatty acid, etc., as well as mixtures thereof. Metal carboxylates typically constitute from about 0.05 wt. % to about 5 wt. %, in some embodiments from about 0.1 wt. % to about 2 wt. %, and in some embodiments, from about 0.2 wt. % to about 1 wt. % of the polymer composition.

Another suitable crosslinking agent composition is a multi-functional crosslinking agent that generally includes two or more reactively functional terminal moieties linked by a bond or a non-polymeric (non-repeating) linking component. By way of example, the crosslinking agent can include a di-epoxide, poly-functional epoxide, diisocyanate, polyisocyanate, polyhydric alcohol, water-soluble carbodiimide, diamine, diol, diaminoalkane, multi-functional carboxylic acid, diacid halide, etc. Multi-functional carboxylic acids and amines are particularly suitable. Specific examples of multi-functional carboxylic acid crosslinking agents can include, without limitation, isophthalic acid, terephthalic acid, phthalic acid, 1,2-di(p-carboxyphenyl)ethane, 4,4′-dicarboxydiphenyl ether, 4,4′-bisbenzoic acid, 1,4- or 1,5-naphthalene dicarboxylic acids, decahydronaphthalene dicarboxylic acids, norbornene dicarboxylic acids, bicyclooctane dicarboxylic acids, 1,4-cyclohexanedicarboxylic acid (both cis and trans), 1,4-hexylenedicarboxylic acid, adipic acid, azelaic acid, dicarboxyl dodecanoic acid, succinic acid, maleic acid, glutaric acid, suberic acid, azelaic acid and sebacic acid. The corresponding dicarboxylic acid derivatives, such as carboxylic acid diesters having from 1 to 4 carbon atoms in the alcohol radical, carboxylic acid anhydrides or carboxylic acid halides may also be utilized. In certain embodiments, aromatic dicarboxylic acids are particularly suitable, such as isophthalic acid or terephthalic acid.

iv. Flow Modifier

A disulfide compound may also be employed in certain embodiments as a flow modifier. Such compounds can undergo a chain scission reaction with the polyarylene sulfide during melt processing to lower its overall melt viscosity. When employed, disulfide compounds typically constitute from about 0.01 wt. % to about 3 wt. %, in some embodiments from about 0.02 wt. % to about 1 wt. %, and in some embodiments, from about 0.05 to about 0.5 wt. % of the polymer composition. The ratio of the amount of the polyarylene sulfide to the amount of the disulfide compound may likewise be from about 1000:1 to about 10:1, from about 500:1 to about 20:1, or from about 400:1 to about 30:1. Suitable disulfide compounds are typically those having the following formula:

R³—S—S—R⁴

wherein R³ and R⁴ may be the same or different and are hydrocarbon groups that independently include from 1 to about 20 carbons. For instance, R³ and R⁴ may be an alkyl, cycloalkyl, aryl, or heterocyclic group. In certain embodiments, R³ and R⁴ are generally nonreactive functionalities, such as phenyl, naphthyl, ethyl, methyl, propyl, etc. Examples of such compounds include diphenyl disulfide, naphthyl disulfide, dimethyl disulfide, diethyl disulfide, and dipropyl disulfide. R³ and R⁴ may also include reactive functionality at terminal end(s) of the disulfide compound. For example, at least one of R³ and R⁴ may include a terminal carboxyl group, hydroxyl group, a substituted or non-substituted amino group, a nitro group, or the like. Examples of compounds may include, without limitation, 2,2′-diaminodiphenyl disulfide, 3,3′-diaminodiphenyl disulfide, 4,4′-diaminodiphenyl disulfide, dibenzyl disulfide, dithiosalicyclic acid (or 2,2′-dithiobenzoic acid), dithioglycolic acid, α,α′-dithiodilactic acid, 6,6′-dithiodilactic acid, 3,3′-dithiodipyridine, 4,4′dithiomorpholine, 2,2′-dithiobis(benzothiazole), 2,2′-dithiobis(benzimidazole), 2,2′-dithiobis(benzoxazole), 2-(4′-morpholinodithio)benzothiazole, etc., as well as mixtures thereof.

v. Nucleating Agent

If desired, a nucleating agent may also be employed to further enhance the crystallization properties of the composition. One example of such a nucleating agent is an inorganic crystalline compound, such as boron-containing compounds (e.g., boron nitride, sodium tetraborate, potassium tetraborate, calcium tetraborate, etc.), alkaline earth metal carbonates (e.g., calcium magnesium carbonate), oxides (e.g., titanium oxide, aluminum oxide, magnesium oxide, zinc oxide, antimony trioxide, etc.), silicates (e.g., talc, sodium-aluminum silicate, calcium silicate, magnesium silicate, etc.), salts of alkaline earth metals (e.g., calcium carbonate, calcium sulfate, etc.), and so forth. Boron nitride (BN) has been found to be particularly beneficial when employed in the polymer composition of the present invention. Boron nitride exists in a variety of different crystalline forms (e.g., h-BN—hexagonal, c-BN—cubic or spharlerite, and w-BN—wurtzite), any of which can generally be employed in the present invention. The hexagonal crystalline form is particularly suitable due to its stability and softness.

The manner in which the polyarylene sulfide, impact modifier, and other optional additives are combined may vary as is known in the art. For instance, the materials may be supplied either simultaneously or in sequence to a melt processing device that dispersively blends the materials. Batch and/or continuous melt processing techniques may be employed. For example, a mixer/kneader, Banbury mixer, Farrel continuous mixer, single-screw extruder, twin-screw extruder, roll mill, etc., may be utilized to blend and melt process the materials. One particularly suitable melt processing device is a co-rotating, twin-screw extruder (e.g., Leistritz co-rotating fully intermeshing twin screw extruder). Such extruders may include feeding and venting ports and provide high intensity distributive and dispersive mixing. For example, the components may be fed to the same or different feeding ports of a twin-screw extruder and melt blended to form a substantially homogeneous melted mixture. Melt blending may occur under high shear/pressure and heat to ensure sufficient dispersion. For example, melt processing may occur at a temperature of from about 50° C. to about 500° C., and in some embodiments, from about 100° C. to about 250° C. Likewise, the apparent shear rate during melt processing may range from about 100 seconds⁻¹ to about 10,000 seconds⁻¹, and in some embodiments, from about 500 seconds⁻¹ to about 1,500 seconds⁻¹. Of course, other variables, such as the residence time during melt processing, which is inversely proportional to throughput rate, may also be controlled to achieve the desired degree of homogeneity.

If desired, one or more distributive and/or dispersive mixing elements may be employed within the mixing section of the melt processing unit. Suitable distributive mixers may include, for instance, Saxon, Dulmage, Cavity Transfer mixers, etc. Likewise, suitable dispersive mixers may include Blister ring, Leroy/Maddock, CRD mixers, etc. As is well known in the art, the mixing may be further increased in aggressiveness by using pins in the barrel that create a folding and reorientation of the polymer melt, such as those used in Buss Kneader extruders, Cavity Transfer mixers, and Vortex Intermeshing Pin mixers. The speed of the screw can also be controlled to improve the characteristics of the composition. For instance the screw speed can be about 400 rpm or less, in one embodiment, such as between about 200 rpm and about 350 rpm, or between about 225 rpm and about 325 rpm. In one embodiment, the compounding conditions can be balanced so as to provide a polymer composition that exhibits improved impact and tensile properties. For example, the compounding conditions can include a screw design to provide mild, medium, or aggressive screw conditions. For example, system can have a mildly aggressive screw design in which the screw has one single melting section on the downstream half of the screw aimed towards gentle melting and distributive melt homogenization. A medium aggressive screw design can have a stronger melting section upstream from the filler feed barrel focused more on stronger dispersive elements to achieve uniform melting. Additionally it can have another gentle mixing section downstream to mix the fillers. This section, although weaker, can still add to the shear intensity of the screw to make it stronger overall than the mildly aggressive design. A highly aggressive screw design can have the strongest shear intensity of the three. The main melting section can be composed of a long array of highly dispersive kneading blocks. The downstream mixing section can utilize a mix of distributive and intensive dispersive elements to achieve uniform dispersion of all type of fillers. The shear intensity of the highly aggressive screw design can be significantly higher than the other two designs. In one embodiment, a system can include a medium to aggressive screw design with relatively mild screw speeds (e.g., between about 200 rpm and about 300 rpm).

### II. Three-Dimensional Printing

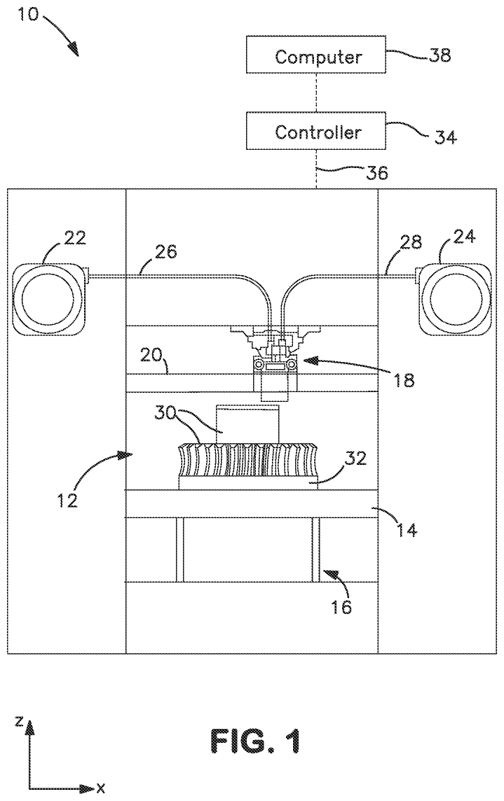

As noted above, the unique properties of the polymer composition are particularly well-suited for forming structures by three-dimensional printing. Various types of three-dimensional printing techniques may be employed, such as extrusion-based systems (e.g., fused deposition modeling), powder bed fusion, electrophotography, etc. When employed in a fused deposition modeling system, for instance, the polymer composition may be employed as the build material that forms the three-dimensional structure and/or the support material that is removed from the three-dimensional structure after it is formed. Referring to FIG. 1, for example, one embodiment of an extrusion-based, three-dimensional printer system 10 is shown that may be employed to selectively form a precursor object containing a three-dimensional build structure 30 and a corresponding support structure 32. In the particular embodiment illustrated, the system includes a build chamber 12 and supply sources 22 and 24. As noted above, the polymer composition of the present invention may be used to form the build structure 30 and/or support structure 32. In those embodiments in which the polymer composition is only employed in the build structure or the support structure, it should be understood any other conventional material can be employed for the other structure. For example, in certain embodiments, the polymer composition of the present invention may be used to form the build structure 30. In such embodiments, suitable materials for the support structure 32 may include conventional materials that are soluble or at least partially soluble in water and/or an aqueous alkaline solution, which is suitable for removing support structure 32 in a convenient manner without damaging build structure 24. Examples of such materials may include those described in U.S. Pat. No. 6,070,107 to Lombardi et al., U.S. Pat. No. 6,228,923 to Lombardi et al., U.S. Pat. No. 6,790,403 to Priedeman et al., and U.S. Pat. No. 7,754,807 to Priedeman et al.

The material for the build structure 30 may be supplied to a nozzle 18 from the supply source 22 via a feed line 26 and the support material for the support structure 32 may be supplied to the nozzle 18 from supply source 24 via a feed line 28. The build chamber 12 likewise contains a substrate 14 and substrate frame 16. The substrate 14 is a platform on which the build structure 30 and support structure 32 are built. The substrate is supported by a substrate frame 16, which is configured to move the substrate 14 along (or substantially along) a vertical z-axis. Likewise, the nozzle 18 is supported by a head frame 20, which is configured to move the nozzle 18 in (or substantially in) a horizontal x-y plane above chamber 12. The nozzle 18 is configured for printing the build structure 30 and the support structure 32 on the substrate 14 in a layer-by-layer manner, based on signals provided from the controller 34. In the embodiment shown in FIG. 1, for example, the nozzle 18 is a dual-tip extrusion nozzle configured to deposit build and support materials from the supply source 22 and the supply source 24, respectively. Examples of such extrusion nozzles are described in more detail in U.S. Pat. No. 5,503,785 to Crump, et al.; U.S. Pat. No. 6,004,124 to Swanson, et al.; U.S. Pat. No. 7,604,470 to LaBossiere, et al., and U.S. Pat. No. 7,625,200 to Leavitt. The system 10 may also include other print nozzles for depositing build and/or support materials from one or more tips. During a print operation, the frame 16 moves the nozzle 18 in the horizontal x-y plane within the build chamber 12, and drive mechanisms are directed to intermittently feed the build and support materials from supply sources 22 and 24. In alternative embodiments, the nozzle 18 may function as a screw pump, such as described in U.S. Pat. No. 5,764,521 to Batchelder, et al. and U.S. Pat. No. 7,891,964 to Skubic, et al.

The system 10 may also include a controller 34, which may include one or more control circuits configured to monitor and operate the components of the system 10. For example, one or more of the control functions performed by controller 34 can be implemented in hardware, software, firmware, and the like, or a combination thereof. The controller 34 may communicate over communication line 36 with chamber 12 (e.g., with a heating unit for chamber 12), the nozzle 18, and various sensors, calibration devices, display devices, and/or user input devices. The system 12 and/or controller 34 may also communicate with a computer 38, which is one or more computer-based systems that communicates with the system 12 and/or controller 34, and may be separate from system 12, or alternatively may be an internal component of system 12. The computer 38 includes computer-based hardware, such as data storage devices, processors, memory modules, and the like for generating and storing tool path and related printing instructions. The computer 38 may transmit these instructions to the system 10 (e.g., to controller 34) to perform printing operations so that the three-dimensional structure are selectively formed.

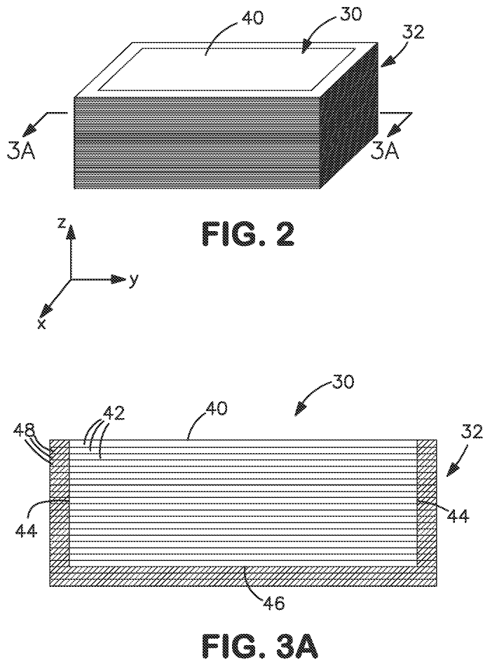

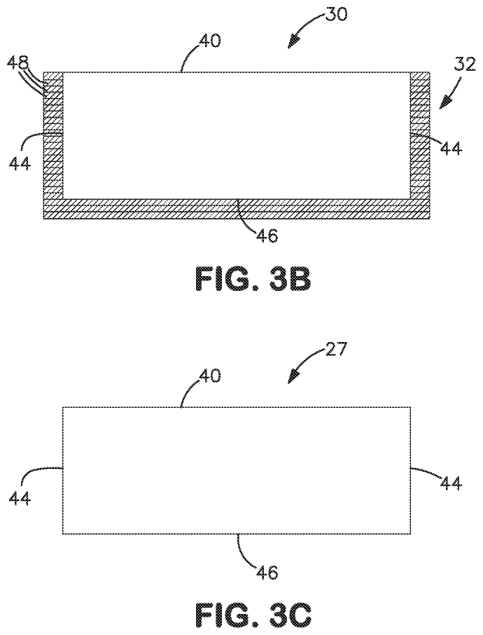

As shown in FIG. 2, the build structure 30 may be printed onto the substrate 14 as a series of successive layers of the build material, and the support structure 32 may likewise be printed as a series of successive layers in coordination with the printing of the build structure 30. In the illustrated embodiment, the build structure 30 is shown as a simple block-shaped object having a top surface 40, four lateral surfaces 44 (FIG. 3A), and a bottom surface 46 (FIG. 3A). Although by no means required, the support structure 32 in this embodiment is deposited to at least partially encapsulate the layers of build structure 30. For example, the support structure 32 may be printed to encapsulate the lateral surfaces and the bottom surface of build structure 30. Of course, in alternative embodiments, the system 10 may print three-dimensional objects having a variety of different geometries. In such embodiments, the system 10 may also print corresponding support structures, which optionally, at least partially encapsulate the three-dimensional objects.

FIGS. 3A-3C illustrate the process of for printing the three-dimensional build structure 24 and support structure 32 in the manner described above. As shown in FIG. 3A, each layer of the build structure 30 is printed in a series of layers 42 to define the geometry of the build structure 30. In this embodiment, each layer of the support structure 32 is printed in a series of layers 48 in coordination with the printing of layers 42 of the three-dimensional build structure 30, where the printed layers 48 of the support structure 32 encapsulate the lateral surfaces 44 and the bottom surface 46 of the build structure 30. In the illustrated embodiment, the top surface 40 is not encapsulated by the layers 48 of the support structure 32. After the print operation is complete, the support structure 32 may be removed from the build structure 30 to create a three-dimensional object 27. For example, in embodiments in which the support material is at least partially soluble in water or an aqueous alkaline solution, the resulting object may be immersed in water and/or an aqueous alkaline solution bath to dissolve the support structure 32.

The polymer composition may be supplied to the three-dimensional printer in a variety of different forms, such as in the form of a sheet, film, fiber, filament, pellet, powder, etc. In one particular embodiment, such as when a fused deposition modeling technique is employed, the polymer composition may be supplied in the form of a filament as described in U.S. Pat. No. 6,923,634 to Swanson, et al. and U.S. Pat. No. 7,122,246 to Comb, et al. The filament may, for example, have an average diameter of from about 0.1 to about 20 millimeters, in some embodiments from about 0.5 to about 10 millimeters, and in some embodiments, from about 1 to about 5 millimeters. The filament may be included within a printer cartridge that is readily adapted for incorporation into the printer system. The printer cartridge may, for example, contains a spool or other similar device that carries the filament. For example, the spool may have a generally cylindrical rim about which the filament is wound. The spool may likewise define a bore or spindle that allows it to be readily mounted to the printer during use.

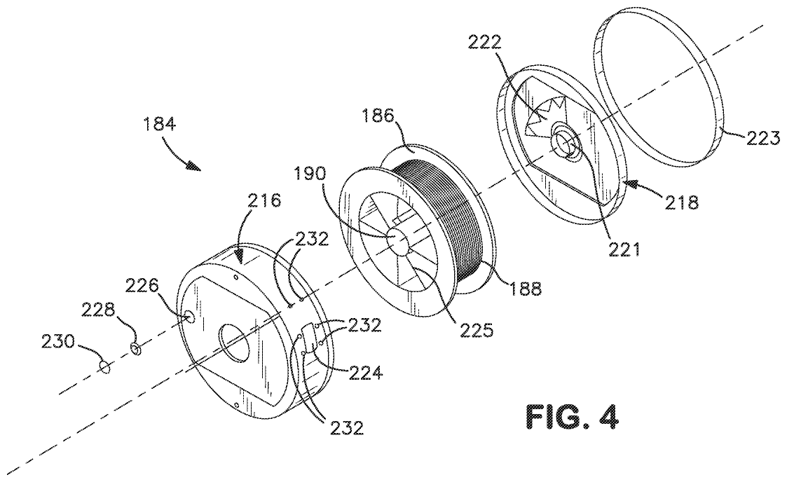

Referring to FIG. 4, for example, one embodiment of a spool 186 is shown that contains an outer rim about which a filament 188 is wound. A generally cylindrical bore 190 is also defined within a central region of the spool 186 about which multiple spokes 225 are axially positioned. Although not required, the printer cartridge may also contain a housing structure that encloses the spool and thus protects the filaments from the exterior environment prior to use. In FIG. 4, for instance, one embodiment of such a cartridge 184 is shown that contains a canister body 216 and a lid 218 that are mated together to define an interior chamber for enclosing the spool 186. In this embodiment, the lid 218 contains a first spindle 227 and the canister body 216 contains a second spindle (not shown). The spool 186 may be positioned so that the spindles of the canister body and/or lid are positioned within the bore 190. Among other things, this can allow the spool 186 to rotate during use. A spring plate 222 may also be attached to the inside of the lid 218 that has spiked fingers, which are bent to further enhance rotation of the spool 186 in only the direction that will advance filament out of the cartridge 184. Although not shown, a guide block may be attached to the canister body 216 at an outlet 224 to provide an exit path for the filament 188 to the printer system. The guide block may be fastened to the canister body 216 by a set of screws (not shown) that can extend through holes 232. If desired, the cartridge 184 may be sealed prior to use to help minimize the presence of moisture. For example, a moisture-impermeable material 223 (e.g., tape) may be employed to help seal the lid 218 to the canister body 216. Moisture can be withdrawn from the interior chamber of the canister body 216 through a hole 226, which can thereafter be sealed with a plug 228. A moisture-impermeable material 230 may also be positioned over the plug 228 to further seal the hole 226. Before sealing the cartridge 184, it may be dried to achieve the desired moisture content. For example, the cartridge 184 may be dried in an oven under vacuum conditions. Likewise, a desiccant material may also be placed within the cartridge 184, such as within compartments defined by the spokes 225 of the spool 186. Once fully assembled, the cartridge 184 may optionally be sealed within a moisture-impermeable package.

In addition to being supplied in the form of a filament, the polymer composition may also be supplied to the fused deposition modeling system of FIG. 1 in other forms. In one embodiment, for instance, the polymer composition may be supplied in the form of pellets. For instance, the pellets may be supplied via a hopper (not shown) to a viscosity pump (not shown) that deposits the polymer composition onto the substrate 14. Such techniques are described, for instance, in U.S. Pat. No. 8,955,558 to Bosveld, et al., which is incorporated herein by reference. The viscosity pump may be an auger-based pump or extruder configured to shear and drive successive portions of received pellets and may be supported by a head frame 20 that can move the viscosity pump and/or hopper in the horizontal x-y plane.

Of course, the three-dimensional printing system is by no means limited to fused deposition modeling. For instance, a powder bed fusion system may likewise be employed in certain embodiments of the present invention. In such embodiments, the polymer composition is generally provided in the form of a powder containing a plurality of particles. The size of the particles may be selectively controlled to help facilitate three-dimensional printing. The volume-based median (D50) particle size may, for instance, range from about 0.5 to about 200 micrometers, in some embodiments from about 1 to about 100 micrometers, in some embodiments from about 2 to about 80 micrometers, and in some embodiments, from about 10 to about 50 micrometers, such as determined by laser diffraction. The particle size distribution may also be relatively narrow such that at least 99% by volume (D99) of the microparticles have of about 500 micrometers or less, in some embodiments about 350 micrometers or less, and in some embodiments, about 300 micrometers or less, such as determined by laser diffraction. Further, the particles may also be generally spherical to help improve processability. Such particles may, for example, have an aspect ratio (ratio of length to diameter) of from about 0.7 to about 1.3, in some embodiments from about 0.8 to about 1.2, and in some embodiments, from about 0.9 to about 1.1 (e.g., about 1).

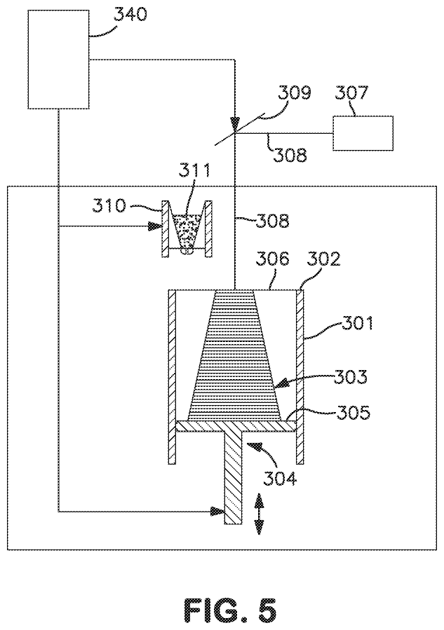

Generally speaking, powder bed fusion involves selectively fusing the powder within a powder bed to form the three-dimensional structure. The fusion process may be initiated by an energy source, such as a laser beam (e.g., laser sintering), electron beam, acoustic energy, thermal energy, etc. Examples of such systems are described, for instance, in U.S. Pat. Nos. 4,863,538; 5,132,143; 5,204,055; 8,221,858; and 9,895,842. Referring to FIG. 5, for example, one embodiment of a lasering sintering system is shown. As shown, the system includes a powder bed 301 for forming a three-dimensional structure 303. More particularly, the powder bed 301 has a substrate 305 from which extends sidewalls 302 that together define an opening. During operation, a powder supply 311 is deposited on the substrate 305 in a plurality of layers to form a build material. A frame 304 is moveable in a vertical direction (e.g., parallel to the sidewall of the powder bed 301) to position the substrate 305 in the desired location. A printer head 310 is also provided to deposit the powder supply 311 onto the substrate 305. The printer head 310 and powder bed 301 may both be provided within a machine frame 301. After the powder supply is deposited, an irradiation device 307 (e.g., laser) emits a light beam 308 onto a work plane 306. This light beam 308 is directed as deflected beam 308′ towards the work plane 306 by a deflection device 309, such as a rotating mirror. Thus, the powder supply 311 may be deposited layer-by-layer onto the working surface 305 or a previously fused layer, and thereafter fused at the positions of each powder layer corresponding by the laser beam 8′. After each selective fusion of a layer, the frame 304 may be lowered by a distance corresponding to the thickness of the powder layer to be subsequently applied. If desired, a control system 340 may also be employed to control the formation of the three-dimensional structure on the working surface 305. The control system 305 may include a distributed control system or any computer-based workstation that is fully or partially automated. For example, the control system 340 may be any device employing a general-purpose computer or an application-specific device, which may generally include processing devices (e.g., microprocessor), memory (e.g., CAD designs), and/or memory circuitry for storing one or more instructions for controlling operation of the printer head 310, powder bed 301, frame 304, and/or deflection device 309.

The following test methods may be employed to determine certain of the properties described herein.

### Test Methods

Melting Temperature: The melting temperature (“Tm”) may be determined by differential scanning calorimetry (“DSC”) as is known in the art. The melting temperature is the differential scanning calorimetry (DSC) peak melt temperature as determined by ISO Test No. 11357-2:2013. Under the DSC procedure, samples were heated and cooled at 20° C. per minute as stated in ISO Standard 10350 using DSC measurements conducted on a TA Q2000 Instrument.

Tensile Modulus, Tensile Stress, and Tensile Elongation at Break: Tensile properties may be tested according to ISO Test No. 527:2012 (technically equivalent to ASTM D638-14). Modulus and strength measurements may be made on the same test strip sample having a length of 80 mm, thickness of 10 mm, and width of 4 mm. The testing temperature may be 23° C., and the testing speeds may be 1 or 5 mm/min.

Flexural Modulus and Flexural Stress: Flexural properties may be tested according to ISO Test No. 178:2010 (technically equivalent to ASTM D790-10). This test may be performed on a 64 mm support span. Tests may be run on the center portions of uncut ISO 3167 multi-purpose bars. The testing temperature may be 23° C. and the testing speed may be 2 mm/min.

Notched Charpy Impact Strength: Notched Charpy properties may be tested according to ISO Test No. ISO 179-1:2010) (technically equivalent to ASTM D256-10, Method B). This test may be run using a Type A notch (0.25 mm base radius) and Type 1 specimen size (length of 80 mm, width of 10 mm, and thickness of 4 mm). Specimens may be cut from the center of a multi-purpose bar using a single tooth milling machine. The testing temperature may be 23° C.

Deflection Temperature Under Load (“DTUL”): The deflection under load temperature may be determined in accordance with ISO Test No. 75-2:2013 (technically equivalent to ASTM D648-07). More particularly, a test strip sample having a length of 80 mm, thickness of 10 mm, and width of 4 mm may be subjected to an edgewise three-point bending test in which the specified load (maximum outer fibers stress) was 1.8 Megapascals. The specimen may be lowered into a silicone oil bath where the temperature is raised at 2° C. per minute until it deflects 0.25 mm (0.32 mm for ISO Test No. 75-2:2013).

Melt Viscosity: The melt viscosity (Pa-s) may be determined in accordance with ISO Test No. 11443:2005 at a shear rate of 1,200 s⁻¹ using a Dynisco 7001 capillary rheometer. The rheometer orifice (die) may have a diameter of 1 mm, a length of 20 mm, an L/D ratio of 20.1, and an entrance angle of 180°. The diameter of the barrel may be 9.55 mm+0.005 mm and the length of the rod was 233.4 mm. The melt viscosity is typically determined at a temperature at least 15° C. above the melting temperature, such as 316° C.

Molecular Weight: The samples may be analyzed using a Polymer Labs GPC-220 size exclusion chromatograph. The instrument may be controlled by Precision Detector software installed on a Dell computer system. The analysis of the light scattering data may be performed using the Precision Detector software and the conventional GPC analysis was done using Polymer Labs Cirrus software. The GPC-220 may contain three Polymer Labs PLgel 10 μm MIXED-B columns running chloronaphthalene as the solvent at a flow rate of 1 ml/min at 220° C. The GPC may contain three detectors: Precision Detector PD2040 (static light scattering); Viscotek 220 Differential Viscometer; and a Polymer Labs refractometer. For analysis of the molecular weight and molecular weight distribution using the RI signal, the instrument may be calibrated using a set of polystyrene standards and plotting a calibration curve.

Particle Size Distribution: Particle size analysis may be carried out via laser diffraction as is known in the art. Before analysis, a water basin may be cleaned out thoroughly before running new samples. The instrument may be allowed to auto rinse for a couple of minutes. A “standard operating method” may be set up pertaining to each sample being tested. More particularly, PIDS (Polarization Intensity Differential Scattering) may be activated to calculate particle sizes from 0.017 μm to 2,000 μm. Sample name, density, and refractive index may be entered (refractive index of water is taken into account). Instrument alignment and offsets may be measured. A background may be run with every sample (if background is too large, the system may be cleaned). The sample may be loaded into the water basin (small amount of a neutral dispersant can be used if the sample did not mix well into the water basin). Results may be collected after the method completes three (3) 90-second runs. Of the three runs, the largest distribution may be selected as the particle size (largest size case scenario). If there is a large discrepancy or inconsistent trend between the runs, the sample may be run again to verify previous results.

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A three-dimensional printing method comprising selectively forming a three-dimensional structure from a polymer composition, wherein the polymer composition comprises a polyarylene sulfide and an impact modifier.

2. The method of claim 1, wherein the polyarylene sulfide is a linear polyphenylene sulfide.

3. The method of claim 1, wherein the impact modifier includes an epoxy-functional olefin polymer.

4. The method of claim 1, wherein the polymer composition is formed by melt processing the polyarylene sulfide and the impact modifier in the presence of a crosslinking agent.

5. The method of claim 4, wherein the crosslinking agent includes an aromatic dicarboxylic acid.

6. The method of claim 4, wherein the crosslinking agent includes a metal carboxylate.

7. The method of claim 1, wherein the polymer composition is selectively extruded through a nozzle to form the three-dimensional structure.

8. The method of claim 7, wherein the polymer composition is in the form of a filament.

9. The method of claim 7, wherein the polymer composition is in the form of a pellet.

10. The method of claim 1, wherein the polymer composition is selectively fused to form the three-dimensional structure.

11. The method of claim 10, wherein the polymer composition is in the form of a powder.

12. The method of claim 11, wherein the polymer composition is selectively fused using thermal energy, a laser beam, electron beam, acoustic energy, or a combination thereof.

13. The method of claim 1, wherein the three-dimensional structure is formed at a temperature from about 225° C. to about 280° C.

14. A printer cartridge for use in a three-dimensional printing system, the printer cartridge comprising a filament that is formed from a polymer composition, wherein the polymer composition comprises a polyarylene sulfide and an impact modifier.

15. The printer cartridge of claim 14, wherein the filament is wound around a rim of a spool.

16. A three-dimensional printing system comprising:
a supply source containing a polymer composition, wherein the polymer composition comprises a polyarylene sulfide and an impact modifier; and
a nozzle that is configured to receive the polymer composition from the supply source and deposit the composition onto a substrate.

17. The system of claim 16, wherein the supply source is a printer cartridge containing a filament, wherein the filament comprises the polymer composition.

18. The system of claim 16, wherein the supply source is a hopper containing pellets, wherein the pellets comprise the polymer composition.

19. The system of claim 18, further comprising a viscosity pump that contains the nozzle, wherein the viscosity pump is configured to receive the pellets from the hopper and extrude the pellets through the nozzle onto the substrate.

20. A three-dimensional printing system comprising:
a powder supply comprising a plurality of particles formed from a polymer composition, wherein the polymer composition comprises a polyarylene sulfide and an impact modifier;
a powder bed configured to receive the powder supply; and
an energy source for selectively fusing the powder supply when present within the powder bed.

21. The system of claim 20, wherein the particles have a volume-based median particle size of from about 0.5 to about 200 micrometers.
